(19) United States
(12) Patent Application Publication
(10) Pub. No.: US 2008/0014849 A1
(43) Pub. Date: Jan. 17, 2008

(54) METHOD OF SETTING AND CONTROLLING COIN STORE OPERATING LEVELS WITH PROMPTING

(75) Inventors: Joseph L. Levasseur, Chesterfield, MO (US); Mark Leibu, St. Louis, MO (US); Thomas S. Paczkowski, Wildwood, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: COIN ACCEPTORS, INC., St. Louis, MO (US)

(21) Appl. No.: 11/830,594

(22) Filed: Jul. 30, 2007

Related U.S. Application Data
(63) Continuation of application No. 11/778,522, filed on Jul. 16, 2007.
(60) Provisional application No. 60/820,745, filed on Jul. 28, 2006.
(60) Provisional application No. 60/862,342, filed on Oct. 20, 2006.
(60) Provisional application No. 60/807,425, filed on Jul. 14, 2006.

(51) Int. Cl. G07D 9/00

(52) U.S. Cl. 453/16; 453/39; 453/58

(57) ABSTRACT

A method for displaying coin store operating levels in a coin changer comprising the steps of activating a visual display to show recommended coin denominations and coin operating levels for a plurality of coin stores and manually positioning level indicators attached to each of said plurality of coin stores to a position indicated by the visual display, the coin store having a plurality of marked positions. An apparatus for employing the method is also disclosed.

The present application claims priority to U.S. Provisional Patent Application Nos. 60/820,745, filed Jul. 28, 2006, and 60/862,342, filed Oct. 20, 2006. The contents of said applications are incorporated herein by reference. The present application is also a continuation of U.S. patent application Ser. No. 11/778,522, filed Jul. 16, 2007, which claims priority to U.S. Provisional Patent Application Ser. No. 60/807,425 Jul. 14, 2006. The contents of said applications are incorporated herein by reference.

### FIELD OF THE INVENTION

The present invention relates to a method and apparatus to control desired levels of stores for payback in a coin changer.

### DESCRIPTION OF THE RELATED ART

During the past there have been numerous techniques and designs to manage the level of coins in coin stores for payout in a coin changer. In particular there have been devices located at various locations at the coin stores to detect the presence of coins to insure coin availability for payout, prevent overfilling, and to limit the level of use. Various devices such as lever operated switches, coin diverter levers to prevent overflow, optic devices, and coils have been utilized.

Another way of controlling the level of coins in the coin stores of a coin changer is disclosed in U.S. Pat. No. 4,587,984, now expired and assigned to the present assignee. This discloses the level of coin operation in one or more coin stores using no sensors at the coin stores and accomplishes control for each tube level by subtracting coins as they are discharged during payout and adding when they are directed to each coin store. When the memory goes above set levels, the coins are diverted to the cash box. When the coin level is too low then no coin is to be discharged.

Another technique is disclosed in U.S. Pat. No. 4,774,841 which uses a short duration acoustic signal that is directed downward from the top of a coin store and the time measured for the signal to reflect back from the top of the coin store stack relates to the height of the coin stack. This information is used to control the coin store levels and determine the approximate coin count for the coin store. The contents of the '841 patent is incorporated herein by reference.

Disclosed are means to indicate audibly and/or visually to prompt the said operator means to add or discharge coin stores when levels are reached, and with means to manually reset each said coin store operating level to its new zero starting point.

A provisional application assigned to the present assignee discloses a light source to illuminate the coin stores when coin stores are to be serviced.

A method to alter the desired float level for coin stores is disclosed in European Patent Publication EP1031950A1. This publication discloses that manually adding or subtracting coins at each coin store is memorized as altered float levels for subsequent use. U.S. Pat. No. 6,623,349 discloses apparatus for enabling a float operation to automatically adjust the coin routing to or from the coin stores to leave a predetermined collective value of different denominations. Dependant disclosures relate to automatically adjusting the collective value of the coins and denominations to be utilized.

What is needed is an inexpensive method and system of change making that is simpler for an operator to initiate, maintain, and to reset. Simplicity is also needed for change making when providing greater capacity for any denomination and a greater number of denominations.

### SUMMARY OF THE INVENTION

A method for displaying coin store operating levels in a coin changer comprising the steps of activating a visual display to show recommended coin denominations and coin operating levels for a plurality of coin stores and manually positioning level indicators attached to each of said plurality of coin stores to a position indicated by the visual display, the coin store having a plurality of marked positions. An apparatus for employing the method is also disclosed.

### BRIEF DESCRIPTION OF THE DRAWINGS

Referring now to the drawings in which like reference numbers represent corresponding parts throughout:

FIG. 1 is a drawing illustrating six coin stores according to an embodiment of the present invention;

FIG. 2 through 5 are diagrams of exemplary combinations of coin store denomination assignments and operating levels according to an embodiment of the present invention;

FIG. 6 is a diagram showing recommended initial coin store assignments for six coin stores at various sales prices according to an embodiment of the present invention;

FIG. 7 is a drawing of a coin acceptor showing a display and operator activation buttons according to an embodiment of the present invention;

FIG. 8 is a drawing showing a coin store with a sliding level indicator according to an embodiment of the present invention;

FIG. 9 is a drawing of the customized display showing customer identification according to an embodiment of the present invention;

FIG. 10 is a drawing of the customized display showing the asset number according to an embodiment of the present invention;

FIG. 11 is a drawing of the customized display showing the configuration according to an embodiment of the present invention;

FIG. 12 is a drawing of the customized display showing the software/hardware configuration according to an embodiment of the present invention;

FIG. 13 is a drawing of the customized display showing the self check configuration according to an embodiment of the present invention;

FIG. 14 is a drawing of the customized display showing the coin store status according to an embodiment of the present invention;

FIG. 15 is a drawing of the customized display showing the coin store configuration according to an embodiment of the present invention;

FIG. 16 is a drawing of the customized display showing the overall status according to an embodiment of the present invention;

FIG. 17 is a chart showing a method for determining the requirements for change making at different sales prices and sales volumes according to an embodiment of the present invention;

FIG. 18 is a chart showing a method for determining the requirement for assigning the denominations and operating levels for the coin stores according to an embodiment of the present invention;

FIG. 19 is a chart showing the history of coin usage activity according to an embodiment of the present invention; and

FIG. 20 is a flow chart showing an algorithm for determining the requirement for assigning the denominations and operating levels for the coin stores according to an embodiment of the present invention.

### DETAILED DESCRIPTION OF PREFERRED EMBODIMENT

In the following description, reference is made to the accompanying drawings which form a part hereof, and which is shown, by way of illustration, several embodiments of the present invention. It is understood that other embodiments may be utilized and structural changes may be made without departing from the scope of the present invention.

The present invention discloses a method and apparatus for an operator of a coin changer to manually activate a visual display of recommended coin store operating levels which is used to position level indicators that are attached to coin stores. The operator then discharges or adds coins for each coin store to those level indicators. The operator then manually sets the coin store operating levels to zero for directing subsequent coin deposits to an appropriate coin store when it is at a level less than zero.

The visual display of recommended float levels is controlled by software which determines stored coin denomination proportions for a given sales price and the amount of coins to be assigned to each coin store based on the maximum expected product sales between restocking times. Recommended changes in operating levels are displayed for the operator based on previous activities regarding any minimum requirements reached during a past period of time.

Another feature provides the operator to indicate a total value of coins to be automatically discharged sequentially, one coin at a time from selected coin stores. Still another feature allows the operator to manually indicate a total value of coins for automatically increasing selected coin stores and to then set the operation levels to the new zero.

An additional feature provides customization of customer's identification, asset number, configuration, self check, report, tube configuration, and changer status.

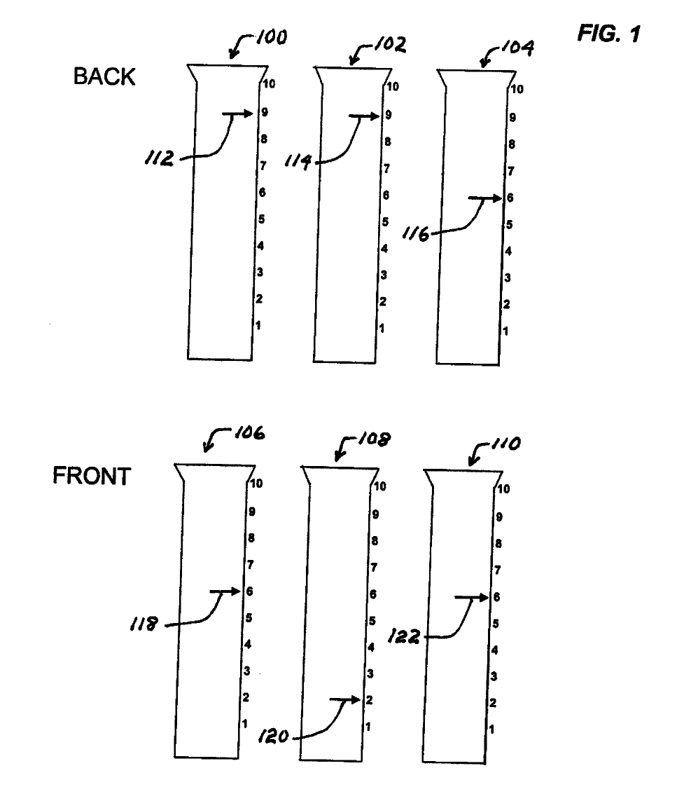

FIG. 1 is a drawing representing three coin stores 100, 102, and 104 which are behind three front coin stores 106, 108, and 110. Each of the six coin stores 100 through 110 have movable level indicators 112 through 122, respectively, which can be positioned at various levels. The pointers are placed at recommended coin operating levels for each coin store. Coin stores 100 and 102 are shown at level 9 by level indicators 112 and 114 respectively. Coin stores 104, 106, and 110 are shown at level 6 by level indicators 116, 118, and 122 respectively. Coin store 108 is shown at level 2 by level indicator 120. The coin stores are made of transparent plastic to easily view the coin stack's relationship to the levels 1 through 10 markings associated along each coin store. The movable indicators 112 through 122 are designed to be easily positioned and secured and to provide an easy visible reference.

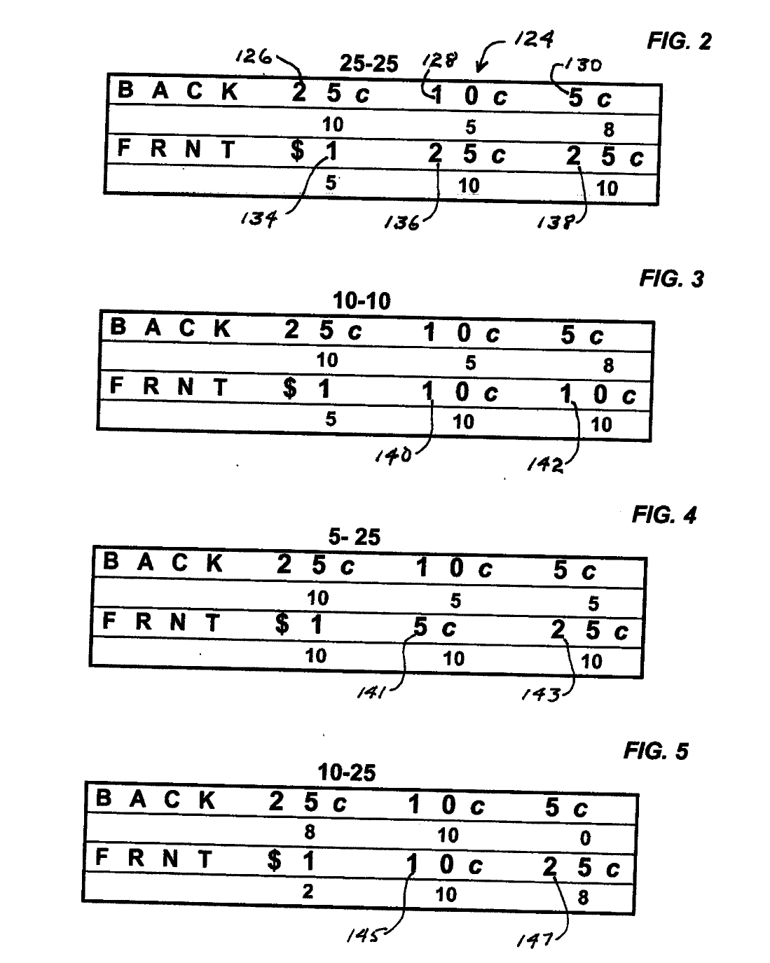

FIG. 2 shows a display presentation 124 recommending that the back three tube denominations be assigned 25c 126, 10c 128, and 5c 130 and be filled to levels 10, 5, and 8, respectively, and that the front three denominations be assigned $1 134, 25c 136, and 25c 138 to be filled to levels 5, 10, and 10, respectively, as shown. In the like manner FIG. 3 shows the same recommendation for all the tubes as in FIG. 2 except 10c 140 to be filled to level 10, and 10c 142 to be filled to level 10 as shown. FIG. 4 shows a second 5 cent 141 denomination and a second 25c 143 denomination to be added for other price points. FIG. 5 shows a second 10 cent 145 denomination and a second 25 cent 147 denomination to be added for still other price points.

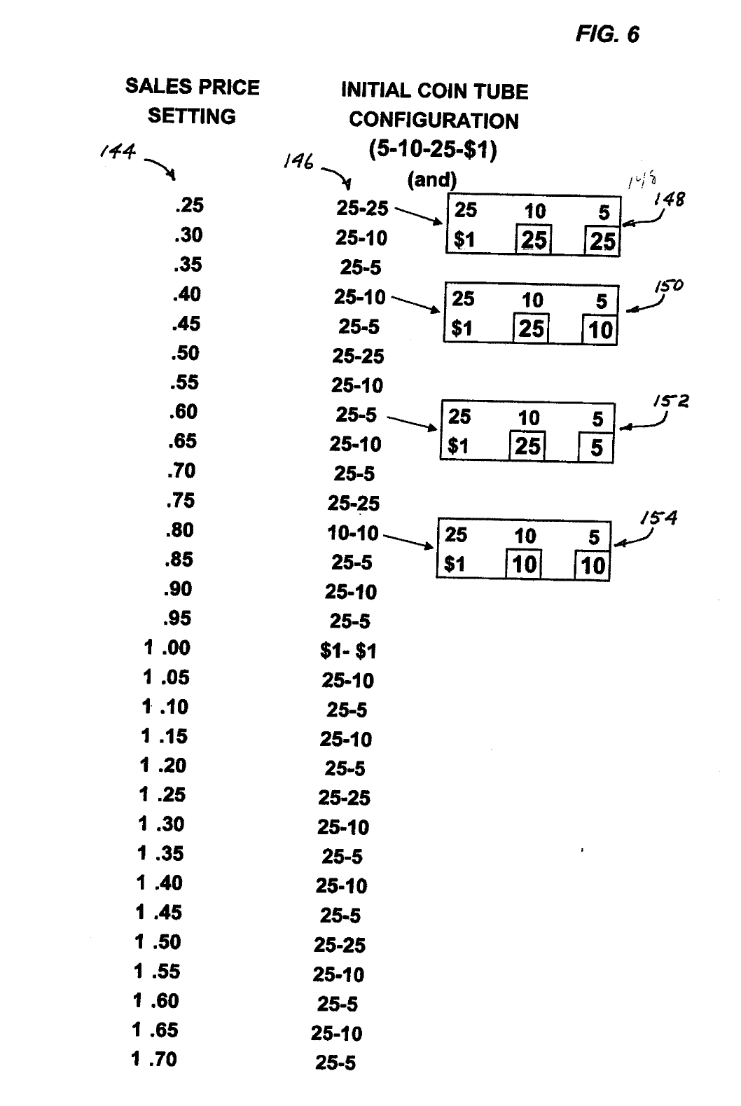

FIG. 6 shows an initial coin store assignment for denominations when six coin stores are available for dispensing and receiving coins. The sales price listing in column 144 is used for reference to column 146 wherein the different sales prices have recommended denominations for assignment to the coin stores. The denomination and operating level assigned each coin store is determined by the change making requirements for products at given price points, the capacity of the vending machine, the amount of sales activity expected, and the time interval for restocking. Outlined sketches 148, 150, 152, and 154 show a few possible denomination assignments of coin stores for a coin changer having six coin stores.

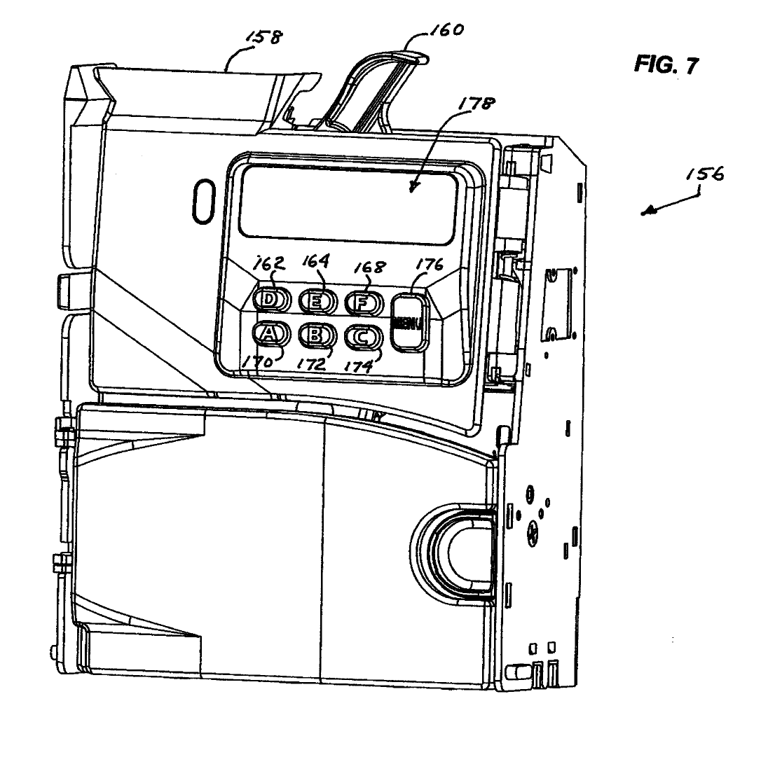

FIG. 7 shows a coin acceptor 156 used for receiving coins at its entry funnel 158, having a coin escrow lever 160 for returning coins deposited, operator activated buttons 162, 164, 168, 170, 172, 174, and 176 for selected functions. The visual display 178 is used to show the operator the various information requested, such as to the assignment of coin stores to the denomination to be used, and the place to position the level indicators 112 through 122 of FIG. 1. The buttons are used to manually discharge coin stores, to reset coin store operating levels to zero, and to enter and review stored data.

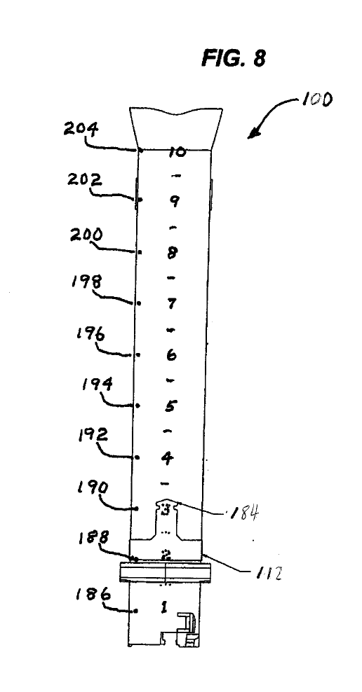

FIG. 8 shows an exemplary coin store 100 with its movable level indicator 112 having a pointer 184 which is positioned with reference to the lowest marking 1 186 through the topmost marking 10 204 in accordance with the visual display 178 of FIG. 7. The markings can indicate the value at each level for the particular denomination of each coin store.

At this point from the above description it is clear to one of ordinary skill in the art that a person might use the display to check the recommended levels for manually filling and discharging the coin stores. Using the coin store level indicators 112 through 122 positioned correctly at each coin store should be much simpler to compare when doing a quick check of the existing coin levels to those previously indicated.

The actual number of coins that are present at any marked level on the coin stores depends mainly on the thickness of the denomination of the coins therein. The accuracy of this factor is mainly determined by the very slight variance in coin thickness of the particular denomination and the total number thereof. The same is true when coins are added or removed while power is off and later sensed by determining the location of the top of the coin stack using sonic or other type of sensing. This variance might be plus or minus one coin depending how thin the denomination was and how tall the coin stack was. Using the general population average for the denomination thickness practically removes the slight variance.

Tracking the degree of coin usage over time at a particular location at a sales price point provides a displayable recommendation for the operator when requested. Manually indicating a total value of coins to be reduced or increased from a present operating level of zero has been described. An audio device used in a tube sensing system such as disclosed in U.S. application Ser. No. 11/234,909, “TUBE STATUS SENSING AND CONTROL”, can be used to audibly signify completion for any step, or for purposes of prompting. The contents of said application are incorporated herein by reference.

It is also anticipated to use a visual method of prompting as disclosed in U.S. Provisional Patent Application No. 60/806,894 which uses a light source directed upon the coin stores to illuminate it and to provide status indications. The contents of said application are incorporated herein by reference.

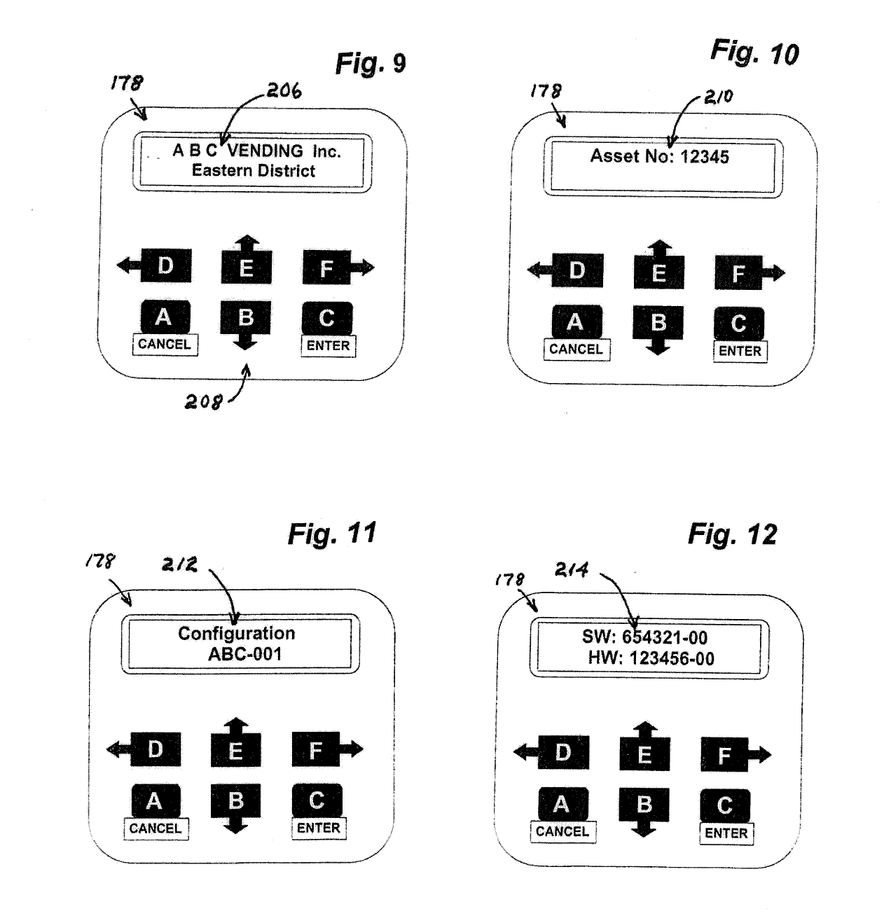

FIG. 9 shows the visual display 178 with the customized identification 206 as requested by the customer, with the service control button location 208 is just beneath. The following FIGS. 10 through 16 are typical of the types, and sequence of information that the customer can have uniquely programmed for his service personnel.

FIG. 10 shows the visual display 178 with the asset number 210;

FIG. 11 shows the visual display 178 showing the configuration identification 212;

FIG. 12 shows the visual display 178 showing the software/hardware configuration 214;

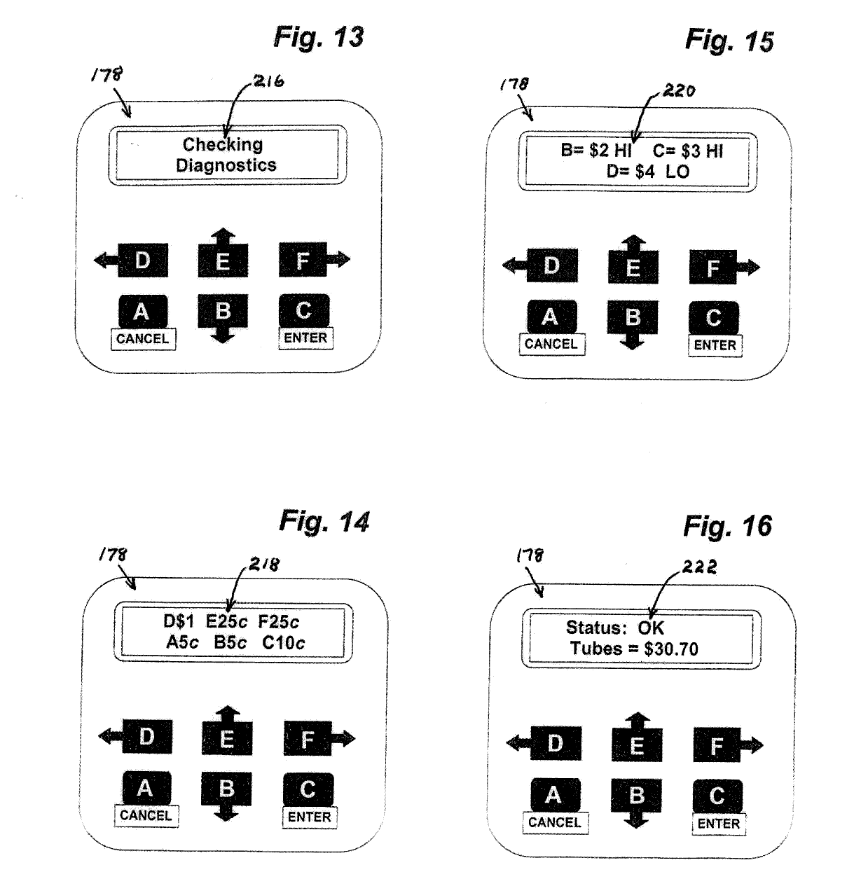

FIG. 13 shows the visual display 178 showing the self check diagnostic information 216;

FIG. 14 shows the visual display 178 showing the coin store configuration 218;

FIG. 15 shows the visual display 178 showing the coin store status 220; and

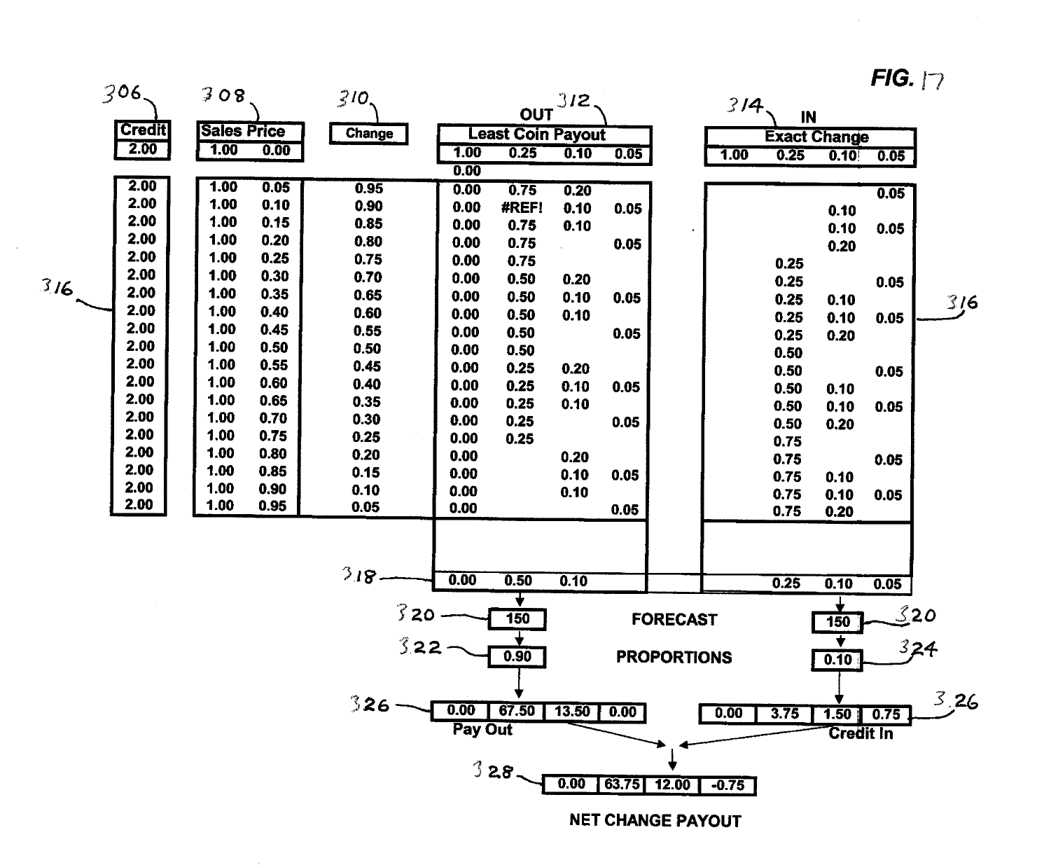

FIG. 16 shows the visual display 178 showing the overall coin store status 222.

The chart in FIG. 17 shows a method of determining the denomination and operating level assignments for the coin stores with the credit 306 column listing the dollar credit amount, the Sales Price 308 column the different sales prices, the Change 310 column the amount of change required, the Least Coin Payout 312 column showing the denominations and the value requirement, and the Exact Change 314 column listing the denominations and value of the coins expected for each sales price when the exact change is deposited. The listing for the sales price of $1.40 at designation 316 is displayed at the lower level 318 showing the denominations and values for the coins to be paid out and to be received in. The forecast amount is entered at locations 320 and the proportion anticipated for change requirement is entered at Proportions 322 entry location. The remaining proportion is shown at Proportions 324 location. The total resultant values are indicated at location 326 with the Net Change Payout 328 showing the results for the entered sales price of $1.40 at line 316, the forecast of 150 entered at Forecast 320, and the value of 0.90 entered at the Proportions 322 entry location. Consequently, by changing the sales price, the forecast, or the proportion of change requirement, the Net Change Payout 328 will change. This example shows the net change payout to be $63.75 in 0.25 coins, $12.00 in 0.10 coins, and a surplus of $0.75 in 0.05 coins. The requirement for $1.00 coins would be needed if $5.00 bills were accepted.

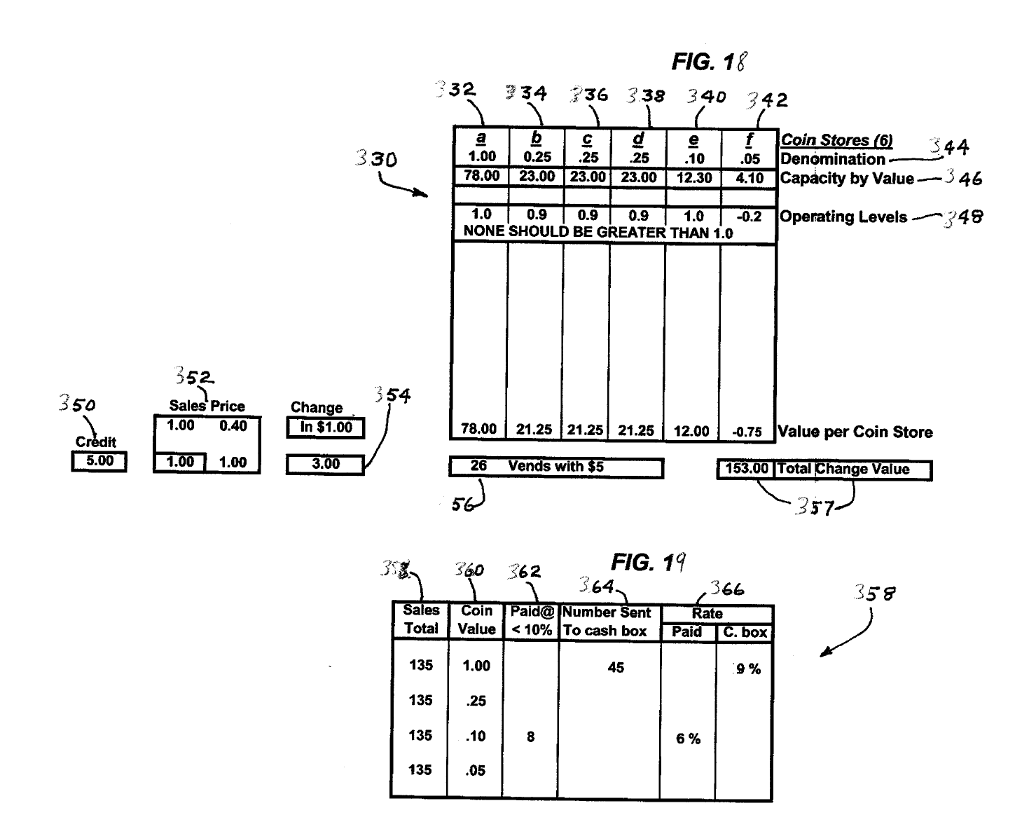

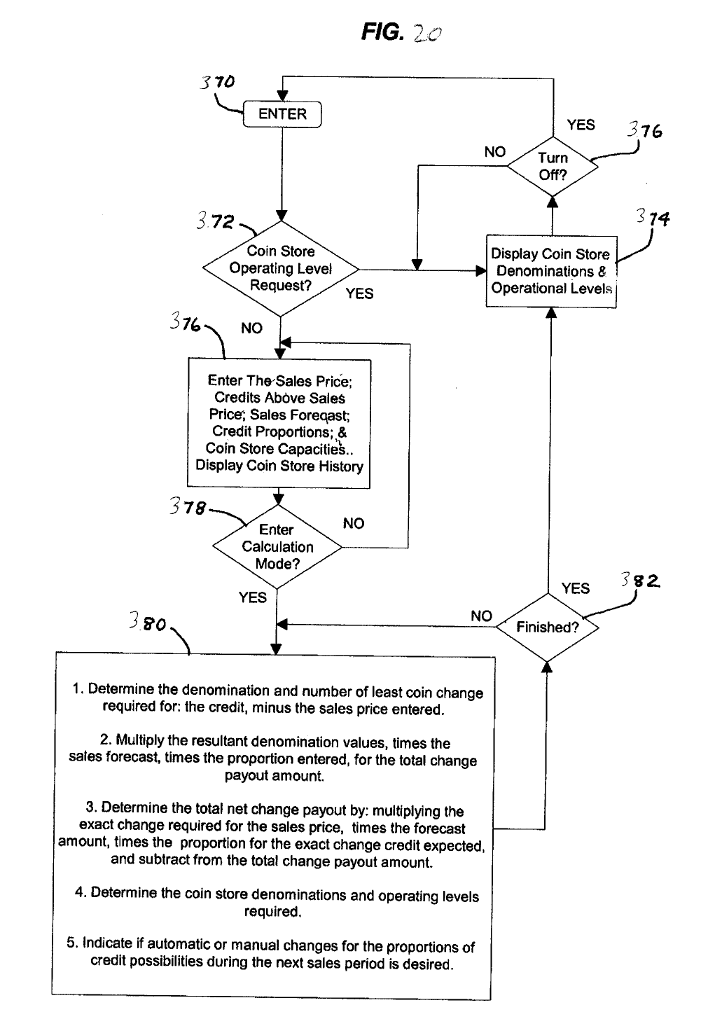

FIG. 18 shows the chart 230 listing the six coin stores a 332 through f 342 with their Denomination 344 listing and the Capacity by Value 346 list. The $63.75 of 0.25 coin requirement of FIG. 17 is provided by assigning three coin stores b 334, c 336, and d 338 with a third of the amount each which is $21.25 and represents about 0.9 of their capacity values. The Operating Levels 348 when at 1.0 are full, half full when at 0.5, and very low when at 0.1, etc. Since the example in FIG. 18 is $12.00 for the 0.10 coin store and the capacity of the coin store e 340 is $12.30, the Operating Levels 348 is about 1.0. Because of the surplus indicated for the 0.05 coins at 328 of FIG. 17 the Operating Levels 348 for coin store f 342 can be set at 1.0 to store them for increased change capacity, and by starting with a minimum amount of coins. Since there is a sixth coin store a 332 for $1.00 coins and having a capacity of $78.00, it can be determined that by entering 5.00 at Credit 350 and 1.40 at Sales Price 352 there will be $3.00 of coins shown at Change 354 and with a $78 coin capacity for coin store a there will be a 26 shown at the Vends with $5 356 location. The total change requirement is shown at Total Change Value 357 of FIG. 18.

FIG. 19 shows a chart 358 of the history of the Coin Values 360 listed with the quantity of them shown as Paid<(less than) 10% 362 levels. The rate level 362 of 10% can be set manually to different values. This number indicates the number of coins that were paid after exceeding a preset lower operating level for that coin denomination or coin store. The Number Sent To Cash Box 364 list indicates the coins that were directed to the cash box because the associated coin store was at its prescribed zero float level setting during those transactions. The percentage rates for each denomination and situation is shown in the Rate 366 listing and is used to recommend denominational or operation level changes of the coin stores. The Rate 366 listing percentages represent, the number paid or sent to the cash box, divided by the Sales Total 368 number. These results are used to recommend changes in coin store denominations and operation levels as well as to predict the proportions of over deposits. The values entered into PROPORTIONS 322 and 324 in FIG. 17 can be accomplished automatically or manually by using the results shown in the Rate 366 portion of FIG. 19. This will improve the Net Change Payout 328 prediction shown in FIG. 17 for the next sales period. Objectives considered are: not to lose a sale because of requiring the exact amount of credit for the sales price; not to restrict the usage of a higher denomination; not providing change making using the least coin payout; running out of change before the end of the sales period; requiring more frequent servicing because of change requirements; and selecting the most effective sales price for the location. Tracking the number of over deposits by 0.05 or 0.10 could indicate to manually or automatically advance the sales price to test the market. If tracking the rate of sales over a time period shows a large deviation, an adjustment in the sales price could be made.

FIG. 12 shows the flow chart starting at ENTER 370 to determine if a request from the Coin Store Operating Level 372 is YES, activating the Display Coin Store Denominations & Operational Levels Block 374 until the Turn Off? Decision 376 is made. If the request from the Coin Store Operating Level 372 is NO, the Enter The Sales Price; Credits above Sales Price; Sales Forecast; Credit Proportions, and Display Coin Store History Block 376 is activated. The said entered data is stored and awaits the Enter Calculation Mode? 378 YES indication which starts the algorithm to determine the coin store denominations and operating levels required at Block 380. At Block 380 the steps include 1. Determine the denomination and number of least coin change required for: the credit, minus the sales price entered. 2. Multiply the resultant denomination values, times the sales forecast, times the proportion entered, for the total change payout amount. 3. Determine the total net change payout by multiplying the exact change required for the sales price, times the forecast amount, times the proportion for the exact change credit expected, and subtract from the total change payout amount. 4. Determine the coin store denominations and operating levels required. As soon as the Finished 382 is signaled YES, then the Display Coin Store Denominations & Operational Levels Block 374 is activated. This provides the operator the information to make any changes needed.

The actual number of coins that are present at any marked level on the coin stores depends primarily on the thickness of the denomination of the coins therein. The accuracy of this factor is mainly determined by the very slight variance in coin thickness of the particular denomination and the total number thereof. The same is true when coins are added or removed while power is off, and later sensed by determining the location of the top of the coin stack using sonic or other type of sensing. This variance might be plus or minus one coin depending how thin the denomination was and how tall the coin stack was. Using the general population average for the denomination thickness practically removes the slight variance.

The forgoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by the details of the embodiments presented in this description. The above specification, examples, and data provide a complete description of the manufacture and use of the invention. Many embodiments of the invention can be made without departing from the spirit and scope of the invention.

What is claimed is:

1. A method for displaying coin store operating levels in a coin changer, comprising the steps of:
activating a visual display to show recommended coin denominations and coin operating levels for a plurality of coin stores; and
manually positioning level indicators attached to each of said plurality of coin stores to a position indicated by the visual display, the coin store having a plurality of marked positions.

2. The method of claim 1 further comprising the steps of
manually discharging or depositing coins to a level of the level indicators; and
manually resetting the recommended coin store operating levels to a zero starting point.

3. A method of manually resetting one or more coin store operating levels in a coin changer comprising the steps of:
manually indicating a total coin value to be discharged;
automatically discharging sequentially one coin at a time from one or more manually selected coin stores until said total value to be discharged is accomplished; and
manually resetting each said coin store operating levels to a zero starting point.

4. A method of manually resetting one or more coin store operating levels in a coin changer comprising the steps of:
manually indicating a total coin value to be added;
accepting deposited coins to one or more manually selected coin stores in a sequential order, one coin at a time until said total value to be added is reached; and
manually resetting said coin store operating levels to zero starting points.

5. A method of determining the total value of coins to be added or removed in a coin changer, comprising the steps of:
manually depressing one or more buttons to display said value to be added or removed;
sensing acoustically the present coin store level total;
comparing the difference between the coin store recommended operating level total to the said present coin tube level total; and
displaying said total value of coins to be added or removed per store.

6. A method of providing recommended coin store denominations and operating levels in a coin changer having a visual display, comprising the steps of:
using stored recommended coin denomination proportions for a given sales price to be used;
determining the number of coin stores to be assigned for each denomination;
computing the operating levels for the coin stores to be used for coin dispensing based on a total value requirement; and
displaying each recommended coin store level.

7. The method of claim 6, whereby visual displayed recommended coin store levels are used to manually position the level indicators attached to the coin stores.

8. The method of claim 7, whereby visual displayed recommended coin store levels are used to set the new float levels of zero start points for each store.

9. An apparatus for displaying and manually setting coin store operating levels in a coin changer, comprising:
a visual display to show recommended operating levels for each coin store;
adjustable level indicators attached to each coin store having a number of marked positions of operating levels; and
means to activate said visual display to indicate where to manually position said level indicators.

10. The apparatus of claim 9 further comprising:
means to add or discharge coin stores according to said displayed value; and
means to manually reset each said coin store operating level to its new zero starting point.

11. The apparatus of claim 9 further comprising:
means to indicate audibly and/or visually to prompt the said operator means to add or discharge coin stores when levels are reached.

12. The apparatus of claim 9, further comprising means to manually add or discharge said coin stores to said level indicators and an input means to manually reset said coin store operating levels to said recommended operating levels to zero starting points.

13. The method of claims 1 further comprising the step of providing an audio signal to indicate a step completed or required.

14. The apparatus of claim 9 further wherein the display shows the customer's identification and the specified display sequence to be available for service personnel when displaying or changing recommended coin stores levels.

15. The apparatus of claim 11 wherein the means to visually prompt the said operator means is a light source.

16. A method of providing recommended coin store denominations and operating levels in a coin changer having a visual display, comprising:
using stored recommended coin denomination proportions for a given sales price to be used;
determining the number of coin stores to be assigned for each denomination;
computing the operating levels for the coin stores to be used for coin dispensing based on a total value requirement; and
displaying each recommended coin store level.

17. The method of claim 16, whereby visual displayed recommended coin store levels are used to manually position the level indicators attached to the coin stores.

18. The method of claim 17, whereby visual displayed recommended coin store levels are used to set the new float levels of zero start points for each store.

19. An apparatus for displaying and manually setting coin store operating levels in a coin changer, comprising: a visual display to show recommended operating levels for each coin store; adjustable level indicators attached to each coin store having a number of marked positions of operating levels; and means to activate said visual display to indicate where to manually position said level indicators.

20. The apparatus of claim 19, further comprising; means to manually add or discharge said coin stores to said level indicators; and an input means to manually reset said coin store operating levels to said recommended operating levels to zero starting points.
